(19) United States
(12) Patent Application Publication
(10) Pub. No.: US 2025/0370493 A1
(43) Pub. Date: Dec. 4, 2025

(54) SYSTEM AND METHOD OF FAST SETTLING BIAS REFERENCE DISTRIBUTION WITH BIAS ACCELERATION AND CHARGE INJECTION COMPENSATION

(71) Applicant: NXP USA, Inc., AUSTIN, TX (US)

(72) Inventors: Marcos Mauricio Pelicia, Austin, TX (US); Himanshu Sharma, San Jose, CA (US)

(21) Appl. No.: 18/676,100

(22) Filed: May 28, 2024

(51) Int. Cl. G05F 3/26

(52) U.S. Cl. CPC G05F 3/262

(57) ABSTRACT

A bias acceleration system for a reference bias generator including a bias accelerator and an activation controller. The reference bias generator includes mirrored transistor devices coupled in a mirrored configuration with a primary bias transistor device at a bias node, in which the primary bias transistor device is coupled to a bias current source which is activated by a reference enable signal. The bias accelerator amplifies bias current applied to the primary bias transistor device and applies amplified current to the bias node in response to the bias current source when activated by the reference enable signal. The activation controller enables the bias accelerator in response to the reference enable signal and disables the bias accelerator when the bias node stabilizes. When one of the mirrored transistor devices is switched, a charge injection compensator compensates for charge injection caused by switching one or off the switched transistor device.

### BACKGROUND

### Field

The present disclosure relates in bias reference generation and distribution, and more particularly to a system and method of providing a fast settling bias reference distribution scheme with bias acceleration and charge injection compensation for system circuitry including low power modules.

### Description of the Related Art

Integrated circuit (IC) products usually require dedicated strategies to match power requirements in low power applications, such as, for example, wearables (e.g., smart watch), smart monitoring systems (e.g., personal medical devices), tracking devices, etc. It is not uncommon to use different circuit versions for each of multiple different power modes, creating additional structures for mode transitions that are dependent on settling time of many internal modules. Low power modules that can operate in a unique mode in all operating conditions provides simpler and faster IC operations. It may include low current bias references to attend low power demands while also including high current bias references to meet higher power demands. In order to conserve energy to the extent possible, a low power bias reference may be included to generate low current references which is leveraged to also generate high current bias references using a mirrored configuration or the like. Low power circuits, however, are known to take a long time to settle, often not meeting wake-up timing specifications for all power modes. In addition, low power circuits are more sensitive to charge injection during enabling and disabling events.

### BRIEF DESCRIPTION OF THE DRAWINGS

Embodiments of the present invention are illustrated by way of example and are not limited by the accompanying figures. Similar references in the figures may indicate similar elements. Elements in the figures are illustrated for simplicity and clarity and have not necessarily been drawn to scale.

FIG. 1 is a simplified block diagram of a system including a bias reference generator implemented according to one embodiment.

FIG. 2 is a simplified schematic and block diagram of a bias reference generator implemented according to one embodiment that may be used as the bias reference generator of FIG. 1.

FIG. 3 is a simplified schematic and block diagram of a bias reference generator implemented according to another embodiment that may be used as the bias reference generator of FIG. 1.

FIG. 4 is a schematic diagram of a charge injection compensator implemented according to another embodiment.

### DETAILED DESCRIPTION

A bias acceleration system and method described herein overcomes deficiencies of conventional configurations by accelerating bias settling time and providing charge injection compensation. Settling time acceleration allows fast settling time when transitioning from standby to higher power modes. Charge injection compensation enables low disturbance during internal enabling events to activate higher bias current sources. In addition, a bias acceleration system and method described herein does not increase the overall power consumption so that applicable low power requirements are easily met.

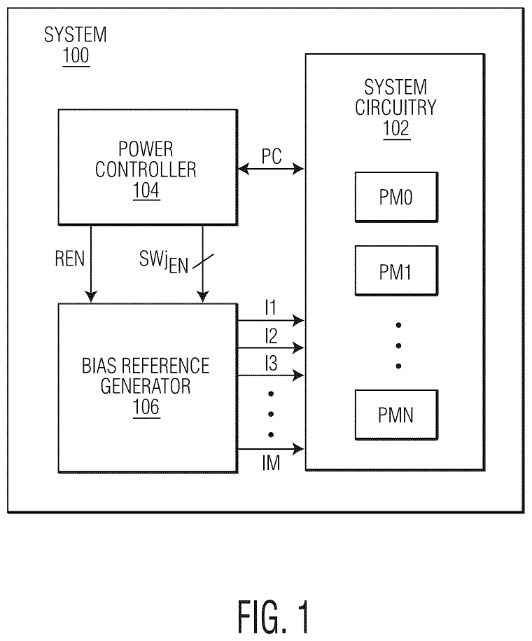

FIG. 1 is a simplified block diagram of a system 100 including a bias reference generator 106 implemented according to one embodiment. The system 100 may be implemented as an integrated circuit (IC) according to a System-on-Chip (SoC) configuration or may alternatively be configured in modular fashion (e.g., separate IC modules coupled together via bus system or the like). The system 100 may be configured for operation at lower power levels or higher power levels depending upon the application and mode of operation. In one embodiment, the system 100 may be configured as a low power module for lower power applications, such as wearables or smart monitoring systems and the like. The system 100 may be implemented as a low power microcontroller configuration or other similar configurations. The system 100 is shown including system circuitry 102 for performing the main functions of the system 100, a power controller 104 for controlling switching between one or more different power modes or levels, and the bias reference generator 106.

The system 100 may be configured with power optimization including fine tuning of power utilization during for different operation modes to match power requirements. The system 100 may have one or more high power or performance modes along with one or more low power or stand-by reduced performance modes with different circuits for each of the different power modes. The system 100 may be automatically or internally configured to operate over multiple operating conditions and may have simpler controllers that allow faster operation transitions. There are, however, additional challenges related to main feature architectures and the bias references distributions that have to fit the accuracy and settling time requirements. Some modules of the system 100, such as switched regulators or voltage detectors or the like, present such architecture characteristics but still need low power and full power current references to operate. Conventional current internal bias reference generation and distribution circuits often suffer from slow settling time during enabling, along with charge injection disturbance on operation values when internal enabling and disabling are performed. The bias reference generator 106 is configured bias acceleration and charge injection compensation to overcome these deficiencies of the conventional configurations.

The system circuitry 102, for example, may include multiple (e.g., N) power mode (PM) circuits (PM0, PM1, . . . . PMN) in which each PM circuit may be separately activated or enabled depending upon the particular power mode of operation at any given time. The power controller 104 and the system circuitry 102 coordinate with each other via power control (PC) signals or the like for controlling the desired mode of operation and corresponding power level modes. In one embodiment, the system 100 may be configured with a stand-by power mode in which most of the system circuitry 102 is powered down or in very low power mode and in which the bias reference generator 106 is turned off. The power controller 104 asserts a reference enable (REN) signal to activate or deactivate the bias reference generator 106. When activated, the bias reference generator 106 may generate up to a multiple number (e.g., M) of bias reference currents I1, I2, I3, . . . , IM, which are provided to the system circuitry 102. One or more of the bias reference currents I1-IM may be non-switched and thus automatically enabled when the bias reference generator 106 is activated. Other ones of the bias reference currents I1-IM may be switched and thus selectively enabled by the power controller 104 via corresponding switch enable signals SWj_{EN}, in which “j” is an index denoting individual ones of one or more switched bias reference currents Ij.

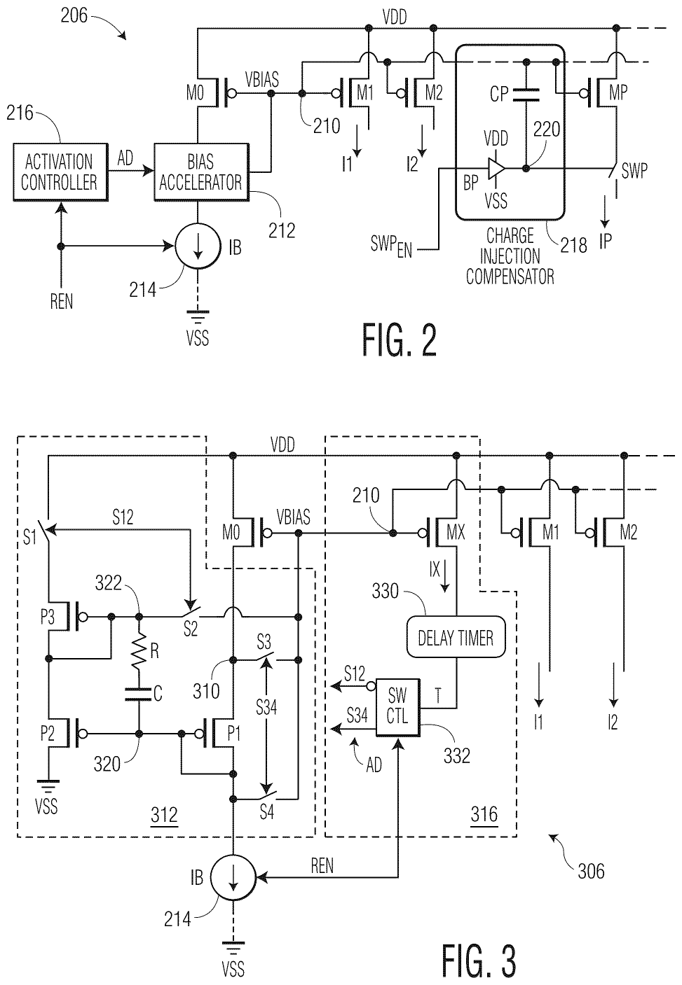

FIG. 2 is a simplified schematic and block diagram of a bias reference generator 206 implemented according to one embodiment that may be used as the bias reference generator 106. The bias reference generator 206 includes a number (e.g., M+1) of P-type metal-oxide semiconductor (PMOS) transistors M0, M1, M2, . . . , MP, . . . , MM (M0-MM in which MM is a last transistor in the series, not shown) for providing corresponding bias reference currents I1-IM. Although M0, M1, M2, and MP are shown as PMOS transistors in the illustrated embodiment, it is understood that different types of transistors or transistor devices may be used for one or more up to all of the transistors M0-MM, each having a control terminal (e.g., gate terminal or base terminal or the like) and a pair of current terminals (e.g., drain terminal and source terminal or collector terminal and emitter terminal or the like) forming a current path. Each of the transistors M0-MM has a drain terminal coupled to a source voltage VDD and a gate terminal coupled to a bias node 210 developing a bias voltage VBIAS.

In the illustrated configuration, M0 is a primary bias transistor having a gate terminal coupled to the bias node 210 and having a source terminal coupled to a bias accelerator 212, which is also coupled to the bias node 210 and to an input of a bias current source 214. The bias current source 214 has an output coupled directly or indirectly to a source reference node, such as VSS, and generates a bias current IB when activated by REN. The bias reference generator 206 also includes an activation controller 216 receiving REN and providing an accelerator disable (AD) signal to an input of the bias accelerator 212. In one embodiment, the bias accelerator 212 is disabled during standby, enabled by the activation controller 216 in response to assertion of REN in order to accelerate startup operation, and then is disabled or otherwise bypassed by the activation controller 216 when a steady state operating condition is met as further described herein.

The remaining transistors M0-MM are configured to provide a corresponding one of the bias reference currents I1-IM, respectively. As shown, for example, M1 has a source terminal providing the bias reference current I1, M2 has a source terminal providing the bias reference current I2, and so on up to MP, which has a source terminal providing a bias current IP (in which “P” is a number between 1 and M) when a switch SWP is closed, and so on up to MM (not shown) providing the corresponding bias reference current IM. It is noted that MP and switch SWP form a switched configuration for selectively providing IP, which is a switched bias reference current activated/deactivated by switch enable signal SWP_{EN} (for j=P). In this case, for example, after REN activates the bias current source 214, IP is provided via MP when SWP_{EN} is asserted high to turn on or close switch SWP.

The bias reference generator 206 further includes a charge injection compensator 218 to facilitate activation of MP for providing IP. The charge injection compensator 218 includes a capacitor CP and a buffer BP having source terminals coupled between VDD and VSS. CP is coupled between the bias node 210 and a node 220, which is coupled to a control terminal of the switch SWP. The buffer BP has an input receiving SWP_{EN} and an output coupled to the node 220 for turning on and off the switch SWP. Although not shown, a similar charge injection compensator may be provided for each switched bias reference.

In one embodiment, the bias reference generator 206 is configured to consume as little power as necessary while also meeting the power requirements of the system circuitry 102. M0 may have a relatively small size and IB provided by the bias current source 214 may have a relatively small magnitude, whereas other transistors, such as M1 or M2, may be significantly larger for generating larger bias currents with larger magnitudes. In a more specific embodiment, for example, IB may be on the order of 20-30 nanoamperes (nA), while I1 may be 50-100 nA, I2 may be 1,000 nA or 1 microampere (μA), IP may have a similar large current magnitude, while additional mirrored transistors may be included to provide a range of bias reference current values. The transistors M1, M2, and MP are sized accordingly.

In a conventional configuration, the bias accelerator 212 was not provided and the gate and source terminals of M0 were coupled together at the input of the bias current source 214. Because IB is relatively small while the other transistors (e.g., M1, M2, MP, etc.) are relatively large with corresponding large gate to source capacitance (CGs), the conventional configuration took a long time to settle to a desired operating level resulting in substantially long activation times in response to assertion of REN. Such long activation times were not suitable for many applications in which it is desired to transition from standby to full operation much faster.

The bias accelerator 212 is configured to inject significantly more startup current than IB when the bias current source 214 is activated by REN. As a result, the bias reference generator 206 settles much more quickly and enables much faster powered operation of the system circuitry 102. In one embodiment, for example, the bias accelerator 212 may be configured to allow the bias reference generator 206 to settle about 10 times faster and thus to allow operation to commence in about 1/10th the time as compared to the conventional configuration. In a more specific example, whereas the conventional configuration may take 75 microseconds (μs) to settle, the bias reference generator 206 equipped with the bias accelerator 212 may settle in 10 us or less. Although actual settling times may vary from one configuration to the next, the bias accelerator 212 is configured to significantly reduce settling time.

It is appreciated, however, that the bias accelerator 212 may consume a correspondingly large amount of additional power if left enabled after settling of the bias reference generator 206. The activation controller 216 is configured to assert AD to deactivate the bias accelerator 212 once steady state is achieved. In the steady state configuration, the gate and source terminals of M0 remain coupled to the bias current source 214 in which the bias accelerator 212 is effectively bypassed and thus is inconsequential to continued operation of the bias reference generator 206 after startup. Also, since the bias accelerator 212 is only activated for a short startup period of time, additional power consumption over time is negligible. When REN is negated to turn off the bias current source 214 and deactivate the bias reference generator 206, the bias reference generator 206, the bias accelerator 212, and the activation controller 216 are disabled in a standby mode to minimize power consumption.

In the conventional configuration, switch enable signals, such as SWP_{EN}, might be provided directly to the control terminal of a corresponding switch, such as SWP, to activate or deactivate the corresponding bias reference current, such as IP. The gate to source capacitance Cos of a switched transistor, such as MP, exhibits substantial voltage variation during enabling and disabling events causing substantial charge injection disturbance. Such charge injection disturbance is particularly problematic when activating or deactivating larger transistors. As an example, when SWP is initially open to disable MP and thus IP, the voltage of the drain terminal of MP is near the voltage level of VDD. When SWP is subsequently closed without the charge injection compensator 218, the voltage of the drain terminal of MP rapidly decreases to some intermediate voltage level defined by the corresponding load receiving IP. The Cas of MP must be charged thus stealing charge from the bias node 210 through the gate terminal of MP. Consequently, the voltage level of VBIAS decreases and the charge of MP Cas capacitance is mostly replenished by the relatively small bias current source 214 limited to the low value of IB. In this manner, recovery in response to turning on or off SWP is relatively slow.

The charge injection compensator 218 alleviates the charge injection issues caused by switching on or off the bias reference current IP during operation. The buffer BP isolates SWP_{EN} and provides a low impedance path via node 220. While SWP_{EN} is low, the buffer BP drives node 220 to VSS so that CP is initially charged to the voltage level of VBIAS. When SWP_{EN} is pulled high to activate IP, the buffer BP begins pulling node 220 high to begin turning on the switch SWP. As switch SWP turns on, MP begins pulling charge via the bias node 210 in a similar manner previously described. In addition, while the voltage of node 220 is increased, the charge on CP is effectively injected into the bias node 210 and into MP. In this manner, CP provides additional charge that would otherwise be provided only by IB (and other minor sources), which significantly reduces the charge injection of MP while being turned on. In this manner, the impact on the bias node 210 is minimized.

If and when SWP_{EN} is pulled low to deactivate IP, the buffer BP begins pulling node 220 low from VDD back to VSS to begin turning off the switch SWP. As switch SWP is turning off, MP begins pushing charge into the bias node 210 in an opposite manner as compared to being turned on. In addition, as the voltage of node 220 is decreased towards VSS, CP begins pulling charge from the bias node 210, which may be provided from the charge injected by MP. In this manner, MP provides the charge for CP while being turned off, which again significantly reduces the charge injection of MP while being turned off. Again, the impact on the bias node 210 is minimized.

It is appreciated, therefore, that the presence of the buffer BP and the capacitor CP facilitates switching of MP while also minimizing the impact of charge injection during activation or deactivation. The capacitance of the capacitor CP is selected based on the size of MP to optimize activation and deactivation of MP when SWP is turned on and off.

FIG. 3 is a simplified schematic and block diagram of a bias reference generator 306 implemented according to another embodiment that may be used as the bias reference generator 106. The bias reference generator 306 also includes M0, M1, and M2 coupled to VDD and the bias node 210 and the bias current source 214 coupled to VSS in a similar manner as the bias reference generator 206. MP, switch SWP, and the charge injection compensator 218 may be included in the bias reference generator 306 and coupled in a similar manner although not shown in FIG. 3 for simplicity. The bias accelerator 212 is replaced by (or otherwise implemented by) a bias accelerator 312, and the activation controller 216 is replaced by (or otherwise implemented by) an activation controller 316.

The bias accelerator 312 includes PMOS transistors P1, P2, and P3, internal switches S1, S2, S3, and S4, a resistor R, and a capacitor C. The source terminal of M0 is coupled to a node 310 within the bias accelerator 312, which is further coupled to one current terminal of switch S3 and to the drain terminal of P1. P1 has gate and source terminals coupled together at a node 320, which is further coupled to the gate terminal of P2, to one end of capacitor C, to one current terminal of switch S4, and to the input of the bias current source 214. The bias node 210 is coupled to one current terminal of switch S2 and to the other current terminals of switches S3 and S4. Switch S1 has its current terminals coupled between VDD and the drain of P3. P3 has gate and source terminals coupled to a node 322, which is further coupled to the other current terminal of switch S2, to one end of resistor R, and to the drain terminal of P2. The other ends of R and C are coupled together. P2 has a source terminal coupled to VSS. Switches S1 and S2 have control terminals receiving an enable signal S12, and switches S3 and S4 have control terminals receiving another enable signal S34. In one embodiment, the RC circuit (resistor R and capacitor C) is provided for stabilization if needed. Otherwise, the RC circuit is removed.

The activation controller 316 includes a PMOS transistor MX, a delay timer 330, and a switch controller (SW CTL) 332 enabled by REN. MX is coupled in a similar manner as M0, M1, etc., having a drain terminal coupled to VDD, a gate terminal coupled to the bias node 210, and a source terminal providing a current IX to the delay timer 330. The delay timer 330 has a timeout or trigger output providing a trigger signal T to an input of the switch controller 332, which has an inverting output providing the enable signal S12 and a non-inverting output providing the enable signal S34. When REN is low, the switch controller 332 is disabled and the enable signals S12 and S34 are all low opening the switches S1, S2, S3 and S4 to completely disable the bias accelerator 312. When REN is asserted high, the enable signal S34 follows the same logic state of T whereas the enable signal S12 follows the opposite logic state of T. The enable signals S12 and S34 collectively implement the disable signal AD.

In standby mode, REN is low so that the bias current source 214 is turned off, the delay timer 330 is reset pulling T low, and the enable signals S12 and S34 are both low so that the switches S1-S4 are opened disabling the bias accelerator 312. When REN is asserted high to activate the bias reference generator 306, S12 goes high closing switches S1 and S2, S34 initially stays low so that switches S3 and S4 initially remain open, and the bias current source 214 is turned on drawing current through M0 and P1. P2 acts as a follower, so that when P1 is turned on, P2 and P3 are turned on and are sized to draw a significantly greater amount of current. P1, P2, and P3 collectively form an amplifier operating in closed loop to drive the voltage of the bias node 210 to be substantially equal to the voltage of node 310. In this manner, the bias node 210 is charged and stabilized much more quickly with operation of the bias accelerator 312.

Meanwhile, after REN is asserted high, MX begins sourcing current IX into the delay timer 330. In one embodiment, the delay timer 330 is configured as a fixed timer that times out after a predetermined amount of time. In one embodiment, for example, IX charges a capacitance (not shown) of an RC timing circuit in which T is pulled high when the capacitance reaches a predetermined target level. When T goes high, S12 goes low turning off thus opening switches S1 and S2 and S34 goes high turning on thus closing switches S3 and S4. In this state, the bias accelerator 312 is effectively bypassed, and the bias node 210 is connected to the source terminal of M0 which is further connected to the input of the bias current source 214, which effectively replicates the standard or conventional configuration during normal operation after steady state is reached.

The gain of the bias accelerator 312 is determined by the transconductance of M0, the transconductance of P2, the the transconductance of P3, the output conductance of M0, and the output conductance of the bias current source 214. The gain of the bias accelerator 312 is sufficiently high so that when enabled by REN, the bias accelerator 312 is configured to allow the bias reference generator 206 to settle much faster and thus to allow operation to commence much more quickly as compared to the conventional configuration. When the bias reference generator 206 is stable, however, the accelerator disable signal AD (e.g., S12 and S34) disables the bias accelerator 312 to avoid any significant increase in power consumption over time.

When REN is subsequently pulled low, the bias current source 214 is turned off, the switches S1-S4 are opened, the current IX decreases to zero, and the delay timer is reset pulling T back low so that the bias reference generator 306 is returned back to the standby mode in its standby state.

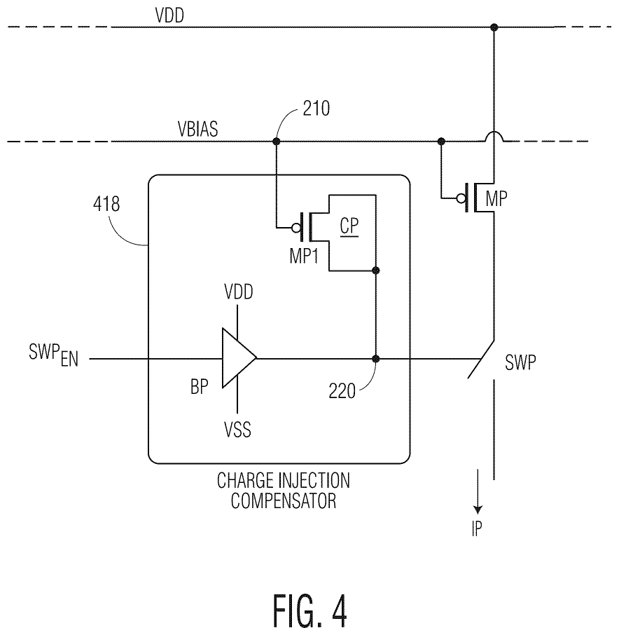

FIG. 4 is a schematic diagram of a charge injection compensator 418 implemented according to another embodiment. The charge injection compensator 418 is substantially similar to the charge injection compensator 218 and includes the buffer BP having an input receiving SWP_{EN} and an output coupled to node 220 in substantially the same manner. The capacitor CP is also provided and coupled between the bias node 210 and the node 220, except more specifically implemented using another PMOS transistor MP1 having its source and drain terminals coupled together at node 220. The size of MP1 is selected so that when coupled as shown, it has a capacitance based on the size of MP to optimize activation and deactivation of MP when SWP is turned on and off in a similar manner previously described for the capacitor CP. The charge injection compensator 418 operates in substantially the same manner as the charge injection compensator 218 previously described to alleviate the charge injection issues caused by switching on or off the bias reference current IP via SWP by SWP_{EN} during operation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims. For example, variations of positive circuitry or negative circuitry may be used in various embodiments in which the present invention is not limited to specific circuitry polarities, device types or voltage or error levels or the like. For example, circuitry states, such as circuitry low and circuitry high may be reversed depending upon whether the pin or signal is implemented in positive or negative circuitry or the like. In some cases, the circuitry state may be programmable in which the circuitry state may be reversed for a given circuitry function.

The terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

1. A bias acceleration system for a reference bias generator, the reference bias generator comprising a plurality of mirrored transistor devices coupled in a mirrored configuration with a primary bias transistor device at a bias node, wherein the primary bias transistor device has a current path coupled to a bias current source activated by a reference enable signal, the bias acceleration system comprising:
a bias accelerator configured to amplify bias current applied to the primary bias transistor device and apply amplified current to the bias node in response to the bias current source when activated by the reference enable signal; and
an activation controller configured to enable the bias accelerator in response to the reference enable signal and to disable the bias accelerator when the bias current source stabilizes.

2. The bias acceleration system of claim 1, wherein the bias accelerator comprises an amplifier configured to drive a voltage of the bias node to a voltage level of an intermediate node coupled between the primary bias transistor device and the bias current source to accelerate stabilization of voltage of the bias node.

3. The bias acceleration system of claim 1, wherein the bias accelerator comprises:
a first transistor device having a current path coupled to the primary bias transistor device at an intermediate node and coupled between the primary bias transistor device and the bias current source;
a second transistor device coupled in a mirrored configuration with the first transistor device; and
a third transistor device coupled to the second transistor device and the bias node formed at the control terminal of the primary bias transistor device;
wherein the first, second, and third transistor devices are configured to drive a voltage of the bias node to a voltage of the intermediate node upon activation of the bias current source.

4. The bias acceleration system of claim 3, wherein the activation controller is configured to bypass the first transistor device and to disconnect the second and third transistor devices from the reference bias generator when the voltage of the bias node stabilizes.

5. The bias acceleration system of claim 3, wherein the activation controller comprises:
a plurality of switches collectively configured to connect the bias accelerator to the reference bias generator when in a first state in response to the reference enable signal and to disconnect the bias accelerator from the reference bias generator when in a second state; and
a timer that is initiated by the reference enable signal and that transitions the plurality of switches from the first state to the second state upon timeout.

6. The bias acceleration system of claim 1, wherein the activation controller comprises:
an auxiliary transistor device coupled in a mirrored configuration with the primary bias transistor device;
a timer coupled to the auxiliary transistor device that is initiated by current received by the auxiliary transistor device in response to the reference enable signal; and
a switch controller that controls at least one switch to disconnect the bias accelerator from the reference bias generator in response to timeout of the timer.

7. The bias acceleration system of claim 6, wherein the switch controller is configured to control the at least one switch to disable the bias accelerator when the reference enable signal indicates a standby mode, to enable the bias accelerator when the reference enable signal indicates activation, and to disable the bias accelerator upon timeout of the timer.

8. The bias acceleration system of claim 1, wherein the reference bias generator includes a switch configured to enable or disable a bias current output of a corresponding one of the plurality of mirrored transistor devices, wherein the bias acceleration system further comprises:
a charge injection compensator that compensates for charge injection caused by the corresponding one of the plurality of mirrored transistor devices when turning the switch on or off.

9. The bias acceleration system of claim 1, wherein the reference bias generator includes a switch configured to enable or disable a bias current output of a corresponding one of the plurality of mirrored transistor devices, wherein the bias acceleration system further comprises:
a capacitive device coupled between the bias node and a control terminal of the switch; and
a buffer having an input receiving an activation signal for turning on and off the switch and having an output coupled to the control terminal of the switch.

10. The bias acceleration system of claim 9, wherein the capacitive device comprises a transistor device having a control terminal coupled to the bias node, and having a drain terminal and a source terminal coupled together at the output of the buffer coupled to the control terminal of the switch.

11. A method of accelerating activation and settling of a reference bias generator, the reference bias generator comprising a plurality of mirrored transistor devices coupled in a mirrored configuration with a primary bias transistor device at a bias node, wherein the primary bias transistor device has a current path coupled to a bias current source at an intermediate node, the method comprising:
activating the bias current source to apply bias current to the primary bias transistor device;
amplifying the bias current applied to the primary bias transistor device to provide amplified current;
applying the amplified current to the bias node; and
removing the amplified current from the bias node when the bias current source stabilizes.

12. The method of claim 11, wherein the amplifying and applying comprises driving a voltage of the bias node to a voltage level of the intermediate node coupled between the primary bias transistor device and the bias current source to accelerate stabilization of voltage of the bias node.

13. The method of claim 11, further comprising:
sensing the bias current applied to the primary bias transistor device; and
wherein the amplifying and applying comprises:
mirroring and amplifying the bias current and providing the amplified current to the bias node; and
driving a voltage of the bias node to a voltage of the intermediate node.

14. The method of claim 13, further comprising disabling the mirroring, amplifying, and providing when the voltage of the bias node stabilizes.

15. The method of claim 11, further comprising:
in response to the activating of the bias current source:
controlling at least one switch to couple a bias accelerator to the reference bias generator; and
initiating a timer; and
controlling the at least one switch to disconnect the bias accelerator from the reference bias generator upon timeout of the timer.

16. The method of claim 15, further comprising controlling the at least one switch to disable the bias accelerator when a reference enable signal indicates a standby mode, to enable the bias accelerator when the reference enable signal indicates activation, and to disable the bias accelerator upon timeout of the timer.

17. The bias acceleration system of claim 11, further comprising:
providing an auxiliary transistor device coupled in a mirrored configuration with the primary bias transistor device;
coupling a timer to the auxiliary transistor device that is initiated by current received by the auxiliary transistor device in response to the activating of the bias current source; and
controlling at least one switch for removing the amplified current from the bias node in response to timeout of the timer.

18. The method claim 11, wherein the reference bias generator includes a switch configured to enable or disable a bias current output of a corresponding one of the plurality of mirrored transistor devices, wherein the method further comprises compensating for charge injection caused by the corresponding one of the plurality of mirrored transistor devices when turning the switch on or off.

19. The method of claim 11, wherein the reference bias generator includes a switch configured to enable or disable a bias current output of a corresponding one of the plurality of mirrored transistor devices, wherein the method further comprises:
coupling a capacitive device between the bias node and a control terminal of the switch; and
coupling a buffer between an activation signal and the control terminal of the switch for turning on and off the switch.

20. The method of claim 19, wherein the coupling a capacitive device comprises a coupling control terminal of a transistor device to the bias node, and coupling a drain terminal and a source terminal to the control terminal of the switch.
